(19) United States
(12) Patent Application Publication
(10) Pub. No.: US 2017/0322549 A1
(43) Pub. Date: Nov. 9, 2017

(54) Processing Apparatus

(71) Applicant: FACTORY AUTOMATION TECHNOLOGY CO., LTD., Chiayi County (TW)

(72) Inventors: Po Cheng SU, Chiayi County (TW); Hsin Hong Hou, Chiayi County (TW); Fan Tien Cheng, Chiayi County (TW); Haw Ching Yang, Chiayi County (TW); Hao Tieng, Chiayi County (TW)

(21) Appl. No.: 15/587,363

(22) Filed: May 4, 2017

(30) Foreign Application Priority Data
May 4, 2016 (TW) 105206397

(51) Int. Cl. G05B 23/02; G01N 29/44; G01N 27/00

(52) U.S. Cl. CPC G05B 23/0289; G05B 23/0267; G05B 23/0283; G01N 27/00; G01N 29/44; G05B 2219/50325

(57) ABSTRACT

A processing apparatus includes a processing unit for processing the workpiece, a processing quality prediction unit connected with the processing unit electrically, a signal interpretation unit connected with the processing quality prediction unit electrically, and a control unit connected with both the processing unit and the signal interpretation unit electrically, wherein when the processing unit is processing the workpiece, the processing quality prediction unit detects the processing signal and sends the signal to the signal interpretation unit, wherein when the signal interpretation unit interprets the processing signal, if there is abnormality in the processing signal, the signal interpretation unit will immediately notify the control unit to stop the processing unit from operating. Therefore, by real-time monitoring the abnormality of the processing signal and stopping suspicious operation during processing, it allows operating personnel to deal with the abnormal condition, so as to greatly reduce the defect rate of the workpiece processing.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention relates to a processing apparatus, and more particularly to a processing apparatus that real-time monitors abnormal condition in the processing signal so as to determine whether to shutdown the machine or not.

### Description of Related Arts

In order to upgrade the efficiency and quality of workpiece processing, the industry utilizes numerical controlled digital processing apparatus to process the processing machine and applies relatively new workpiece processing quality prediction technology to expect that the workpiece processing quality can be timely and effectively managed during the processing. This workpiece processing quality prediction technology is disclosed in Taiwan Patent Number TWI481978B, entitled “Method for predicting machining quality of machine tool” (claiming priority of U.S. Patent Application No. 61/722,250). It can detect various types of processing signal during the processing, including processing vibration signal and processing electrical signal. In the case of processing electrical signal, if there is abnormal condition occurring on the workpiece during the processing, the current of the processing electrical signal will become abnormal due to excess loading, which can infer issues of surface roughness or finishing size of the processing workpiece. If the processing apparatus can be stopped immediately based on the processing electrical signal for troubleshooting, it will be able to greatly reduce the defect rate of the workpiece.

### SUMMARY OF THE PRESENT INVENTION

Therefore, an object of the present invention is to provide a processing apparatus that can reduce the defect rate of the processing workpiece.

Accordingly, the processing apparatus according to the present invention comprises a processing unit for processing the workpiece, a processing quality prediction unit connected with the processing unit electrically, a signal interpretation unit connected with the processing quality prediction unit electrically, and a control unit connected with both the processing unit and the signal interpretation unit electrically, wherein when the processing unit is processing the workpiece, the processing quality prediction unit detects the processing signal and sends the signal to the signal interpretation unit, wherein when the signal interpretation unit interprets the processing signal, if there is abnormality in the processing signal, the signal interpretation unit will immediately notify the control unit to stop the processing unit from operating. Therefore, by real-time monitoring the abnormality of the processing signal and stopping suspicious operation during processing, it allows operating personnel to deal with the abnormal condition, so as to greatly reduce the defect rate of the workpiece processing.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a block diagram illustrating a processing apparatus according to the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

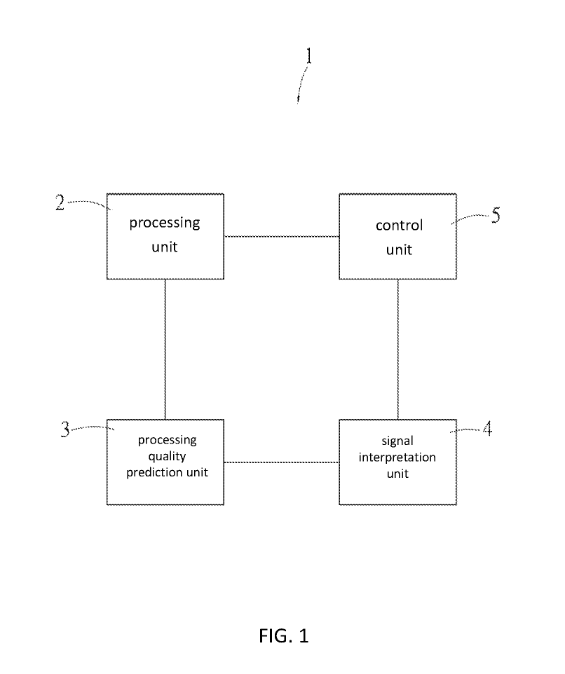

Referring to FIG. 1, the processing apparatus 1 according to a preferred embodiment of the present invention is utilized to process a workpiece and to predict the processing quality of the workpiece. Also, it interprets the processing signal(s) detected during the quality prediction process and determines whether there is abnormal condition or whether it should stop processing the workpiece. The processing apparatus 1 comprises a processing unit 2, a processing quality prediction unit 3, a signal interpretation unit 4, and a control unit 5.

The processing unit 2, which is usually a numerical controlled machine tool, can process a workpiece.

The processing quality prediction unit 3 is connected with the processing unit 2 electrically and utilizes the technology disclosed in Taiwan Patent Number TWI481978B, entitled “Method for predicting machining quality of machine tool.” It mainly applies Computer-Aided Design (CAD) to produce the outline, dimensions, and tolerance of the workpiece and uses Computer Aided Manufacturing (CAM) to generate at least a processing path based on the above dimensions and tolerance as well as the characteristics of the processing unit 2. Also, at least a product accuracy category has to be assigned. The product accuracy category comprises roughness and/or dimension deviation, and etc. The dimension deviation comprises straightness, angularity, perpendicularity, parallelism, and/or roundness, etc. The product accuracy category is associated with the processing path so as to provide a plurality of relevancies between the product accuracy category and the processing path. Then, the processing unit 2 will be utilized to process multiple workpieces according to the processing path to produce workpiece samples and to collect multiple sets of sample detection information of the multiple workpiece samples that relate to the processing path during the processing period. After the operation of sampling, it utilizes algorithm to control the noise of the detection information and convert the detection information of workpiece sample into sample characteristic data in correspondence with characteristic format. After the processing of workpiece sample is finished, the metrology machine is utilized to measure the product accuracy category(ies) of the workpiece sample so as to obtain a set of quality sample data (value of accuracy). Then the quality sample data and the characteristic data of the workpiece sample are utilized to predict the interrelation between the algorithm and processing path and the product accuracy category, in order to build a prediction model for the product accuracy category. That is to say, the characteristic data, quality sample data, and accuracy of workpiece that are obtained when the processing unit 2 processed the workpiece sample, are utilized to form a prediction model.

In short, the processing quality prediction unit 3 generates at least a workpiece processing path for the target workpiece according to the predetermined dimensions, tolerance, and parameters and virtually predicts the processing quality of the workpiece and outputs accurate data of workpiece surface quality. The above mentioned data of workpiece surface quality is converted from several processing signals that comprise processing electrical signal, processing vibration signal, and etc. In the case of processing electrical signal, if the processing electrical signal turns stronger instantly, it indicates poor smoothness of the processing, rendered by factors like blunt tool, improper depth of cut, etc., that can all increase roughness of the workpiece surface or cause abnormal workpiece dimension. On the contrary, if the processing electrical signal is within a certain value range, it means that the processing is smooth and the processing quality of the workpiece surface meets the requirements. Similarly, strength of the processing vibration signal can also be converted into data of workpiece surface processing quality for determining whether the workpiece processing is abnormal or not.

The signal interpretation unit 4 is connected with the processing quality prediction unit 3 electrically and is able to receive at least a processing electrical signal and at least a processing vibration signal from the processing quality prediction unit 3. The signal interpretation unit 4 can also determine whether the processing electrical signal or processing vibration signal is normal. If the processing signal is abnormal, the signal interpretation unit 4 will command the processing quality prediction unit 3 to delete that processing signal.

The control unit 5 is connected with both the processing unit 2 and the signal interpretation unit 4 electrically. When the signal interpretation unit 4 found the processing electrical signal or processing vibration signal abnormal, the control unit 5 will command the processing unit 2 to stop processing the workpiece.

When the processing unit 2 of the processing apparatus 1 according to the present invention is processing a workpiece, the processing quality prediction unit 3 will send electrical current, vibration or other type of processing signals detected to the signal interpretation unit 4. When the signal interpretation unit 4 found the processing signal abnormal, the control unit 5 will send a shutdown signal to the processing unit 2, so the processing unit 2 will stop processing the workpiece and notify the processing quality prediction unit 3 to delete the processing signal of abnormality. Therefore, the processing apparatus 1 according to the present invention can real-time monitor the abnormality of the processing signals during processing and stop the processing operation to allow the operation personnel to deal with the abnormal condition, which greatly reduces the defect rate of the workpiece processing.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A processing apparatus for a workpiece, comprising:
a processing unit for processing the workpiece;
a processing quality prediction unit connected with said processing unit electrically;
a signal interpretation unit connected with said processing quality prediction unit electrically; and a
control unit connected with both said processing unit and said signal interpretation unit electrically, wherein when said processing unit is processing the workpiece, said processing quality prediction unit detects a processing signal and sends said processing signal to said signal interpretation unit, wherein when said signal interpretation unit interprets said processing signal, if there is abnormality in the processing signal, said signal interpretation unit immediately notifies said control unit to stop an operation of said processing unit.

2. The processing apparatus, as recited in claim 1, wherein said signal interpretation unit notifies said processing quality prediction unit to delete said processing signal when said signal interpretation unit found said processing signal abnormal.

3. The processing apparatus, as recited in claim 2, wherein said processing signal is processing electrical signal.

4. The processing apparatus, as recited in claim 2, wherein said processing signal is processing vibration signal.
